(19) United States
(12) Patent Application Publication
(10) Pub. No.: US 2026/0265935 A1
(43) Pub. Date: Sep. 10, 2026

(54) ELECTRODE FOR ELECTROCHEMICAL CELLS

(71) Applicants: ALANTUM EUROPE GMBH, München (DE); FRAUNHOFER-GESELLSCHAFT ZUR FÖRDERUNG DER ANGEWANDTEN FORSCHUNG E.V., München (DE)

(72) Inventors: Christian Immanuel BERNÄCKER, Dresden (DE); Tilo BÜTTNER, Dresden (DE); Gunnar WALTHER, Dresden (DE); Binh PHAM THI, Dresden (DE); Thomas HUTSCH, Dresden (DE); Thomas RAUSCHER, Dresden (DE); Nadine EIßMANN, Dresden (DE); Sebastian HILBERT, Dresden (DE); Andreas TILLMANN, Unterhaching (DE); Sebastian AMTHOR, Mainz (DE); Norma MINAR, München (DE)

(21) Appl. No.: 19/525,143

(22) PCT Filed: Oct. 1, 2024
(86) PCT No.: PCT/EP2024/077631

§ 371 Date: Apr. 1, 2026

(30) Foreign Application Priority Data
Oct. 2, 2023 (DE) 10 2023 209 672.2

(51) Int. Cl. C25B 11/061; C25B 11/031

(52) U.S. Cl. CPC C25B 11/061; C25B 11/031

(57) ABSTRACT

An electrode for electrochemical cells designed to perform electrolysis is a support formed with an open porous metal structure and provided, on the outward-facing surface facing a separator of an electrochemical cell, with a coating that increases the specific surface area or with a coating that increases the specific surface area and exhibits increased catalytic activity. The coating is formed from a metal whose particles are bonded via material bonding to one another and to the surface of the open porous metal structure via sinter bridges and/or an organic binder. The coating is formed with multiple regions, between which uncoated interstices are arranged.

### CROSS-REFERENCE TO RELATED APPLICATIONS

The present disclosure is a U.S. National Stage Application of International PCT Patent Application No. PCT/EP2024/077631, filed Oct. 1, 2024, which claims priority to German Patent Application No. DE 102023209672.2, filed Oct. 2, 2023, the entire contents of each of which are incorporated herein by reference.

### FIELD

The invention relates to an electrode for electrochemical cells designed to perform electrolysis. In particular, the invention is designed for the electrochemical de-composition of water into gaseous hydrogen and oxygen.

### BACKGROUND

Electrodes in these electrochemical cells must exhibit good permeability for gas released during electrolysis. Furthermore, energy consumption during electrolysis should be as low as possible. To achieve this, it is known to use catalysts that can also be applied as a coating on an open porous metal structure and utilized to advantage. For this purpose, sinter-active powders—which may be suitable metal powders, alloy powders, metal oxide powders, or mixtures thereof—can and are used, with their particles fixed to the respective surface through sintering. In addition to catalytic functionality, the application of particles is also used to increase the specific surface area when suitable metal powders are employed. Such coatings are typically applied to the surface of an electrode facing the separator of the electrochemical cell. An increased specific surface area improves the release and detachment of formed gas bubbles from the electrode surface.

The most relevant manufacturing routes for depositing coatings—particularly of a catalyst or a catalyst precursor, or for increasing the specific surface area of an electrode—include electrochemical deposition, plasma spraying, the doctor blading of a dry powder bed or a wet powder suspension or powder paste, the screen printing of powder pastes, wet powder spraying, and the sprinkling of powder particles using a polymer onto a substrate previously coated with a binder. It is also possible to apply a coating to form an electrode. A catalyst can then be applied to this coating.

The coating and/or, if applicable, a catalytically active chemical element can be applied in powder form and bonded via material bonding to a substrate or the sur-face of a coating using a polymer. Subsequently, a thermal treatment may be per-formed, if necessary, to improve the material bond.

It is also known and feasible in the invention to first apply a metallic powder to a surface, with which a porous layer of a suitable thickness for the production of an electrode can be formed. A catalyst can then be applied to this porous metal layer in a second step. For example, nickel can first be applied and sintered, and then, in a second step, the catalyst can be applied to the surface of this sintered layer.

The catalyst can either be a metal powder (which is then sintered again to form the active catalytic phase), a powder/polymer (no sintering; the powder is applied with a polymer (e.g., an ionomer), which is then fixed to the porous surface of the sintered metal layer), or the catalyst can also be applied via a wet chemical meth-od (i.e., depositing metal salts followed by heat treatment).

The manufacturing options described here can also be combined with one another, or at least individual process steps can be carried out multiple times.

The best-known and most active catalysts are activated nickel catalysts (Raney nickel alloys) produced from Ni—Zn or Ni—Al—X (X=transition metals) precursors. Precious metal electrodes are also available, as described in WO 2021/083862A1.

Among the activated nickel catalysts, the Ni—Al—X alloys in particular exhibit exceptional catalytic activity.

Two manufacturing routes are typically followed here:
Plasma spraying of Ni—Al—X alloys followed by leaching of the Al species.
The deposition of Al—X alloys, followed by heat treatment and subsequent leaching of the Al species.

Here, the route involving additional heat treatment is particularly attractive, as the heat treatment step creates a material-and form-locking bond between the forming Ni—Al—X coating and the substrate. During heat treatment, an exothermic reaction occurs between an open porous Ni substrate and the Al—X layer or between a Ni—X substrate and an Al layer, resulting in the formation of Ni—Al—X phases. Consequently, first, mechanical stresses arise within the Ni—Al—X layer as well as between the Ni—Al—X layer and the substrate. Second, a volume change occurs in the region of the forming aluminide phases, and third, the intermetallic Ni—Al—X phases are generally very brittle.

There are two major problems in the production of active electrodes that can be used for water electrolysis.

These are:

Warpage. The fabrication of large (0.3 m to 1.6 m) electrodes is problematic, as coating porous structures often leads to warpage of the substrate. This is mostly related to heat input, which causes mechanical stresses and, due to the formation of the new intermetallic phases, also leads to a volume change. In the case of single-sided substrate coating, it is obvious that an increase in volume on the coated side leads to a convex bulge of the substrate, while a decrease in volume results in a concave bulge. Examples of this include plasma coating processes, electroplating, and powder metallurgy manufacturing routes. Examples of these will be discussed later.

Mechanical stability due to brittle phases. Raney Ni coatings have proven to be the most promising electrodes for both the hydrogen and oxygen evolution reactions. However, the Ni—Al and Ni—Zn phases that form are brittle. In some cases, particularly when using Ni—Al—X, the Ni structures of the substrate—which is formed with an open porous metal structure—undergo a transformation into brittle intermetallic Ni—Al phases. This poses the risk that the stability and thus the structural integrity of the substrate will deteriorate significantly, making it impossible to handle the electrode. The Ni structure has largely transformed into Ni—Al phases. As a result, the originally ductile properties of the open porous metal structure are lost in these regions.

In previous electrode manufacturing processes, these two problems were circumvented because it was simply not possible to produce such electrodes without warpage, leading to the use of alternative catalyst systems. To counteract embrittlement, very thick substrates (such as perforated sheets) have been used, resulting in a very thick structure that provides stability to the electrode. However, this approach is not forward-thinking in terms of resource conservation.

### SUMMARY

It is therefore the object of the invention to provide electrodes for electrochemical cells that are suitable for electrolysis, in particular the separate release of oxygen and hydrogen from water by means of electrolysis, and which exhibit a relatively low mass while possessing sufficient strength to withstand even complex assembly, and in which only small internal mechanical stresses act.

According to the invention, this task is solved by electrodes having the features of Claim 1. Advantageous embodiments and further developments of the invention can be realized with features described in dependent claims.

### DETAILED DESCRIPTION

In the electrodes of the invention, a support formed with an open porous metal structure, preferably a metal foam, is provided on its outward-facing surface—which faces a separator of an electrochemical cell—with a coating that increases the specific surface area or with a coating that increases the specific surface area and exhibits enhanced catalytic activity.

The coating is formed from a metal whose particles are bonded via material bonding to one another and to the surface of the open porous metal structure via sinter bridges.

The coating is formed with multiple regions, between which uncoated interstices are arranged. However, interstices may also be at least partially filled with another material that exhibits properties different from those of an electrode-forming material in a coating. These may include, for example, higher strength, elasticity, hydrophobicity, conductivity, or other catalytic activity (cascade reactivity).

The entire outward-facing surface of the electrode is therefore not completely coated. Uncoated regions remain between the coated regions, forming the interstices. In principle, the coating can be formed using all common metals used to date or rather metals suitable for electrolysis. The coating on the open porous metal structure, which acts as a support, can be formed using all known methods and those previously recognized as suitable. In addition to using a pure metal powder, a coating forming the electrode can also be formed using a metal oxide powder. In this case, at least partial chemical reduction—during which the respective metal is released—is required during the thermal treatment or a subsequent thermal treatment in a reducing atmosphere. Pure metal oxide powder may be used, as well as a mixture containing the metal or another metal with which the respective oxide is formed, and a pure metal. It is also possible to first apply metal powder to a surface and then apply metal oxide powder on top of it. During chemical reduction, the respective oxide is converted into the corresponding metal.

The coating material used to form the electrode should contain at least 90% by mass of metal.

The use of metal oxide powder over pure metal powder has the particular advantage that the metal particles obtained during chemical reduction have smaller particle sizes than is cost-effectively possible with pure metal powder. With the smaller particle sizes of metal forming an electrode, the specific surface area of an electrode can be significantly increased, which can be advantageously utilized in the respective electrochemical reaction. The chemical reduction can be carried out during one or more thermal treatments in a reducing atmosphere. Thereby sintering can also be performed to achieve a bond by material between the coating and the respective surface and between the particles.

Regions that are not to be coated and where interstices are to remain can be temporarily covered during coating. Suitable masks or screens may also be used.

The coating can be formed using known metals as well as Raney alloys, which are known for their increased catalytic activity during electrolysis. The electrodes can be manufactured with or without heat treatment.

Options for forming the coating can also be found, among others, in DE 10 2017 216 566 A1 and DE 10 2017 126 569A1.

The individual coated regions, separated by interstices, should each have a maximum area of 1500 mm², preferably 1200 mm² . At least 80% of the surface of the support on which the coated regions are formed should be coated. The arrangement of the coated regions can be varied. They can be arranged in a row-column pattern, but may also, for example, be formed in a spiral or meandering shape.

The width of the interstices should be at least 0.1 mm, preferably at least 0.5 mm, and most preferably at least 1 mm, to ensure their desired effect.

The coated regions should be homogeneous, for example with regard to the distribution of the metal powder on the surface, and should have a thickness of at least 0.002 mm while still being gas-permeable. In addition to a uniform thickness, the porosity and electrochemical activity should also be maintained uniformly across the entire surface of the respective coated regions.

At least four coated regions should be formed on the outward-facing surface that faces the separator.

Both respective electrodes of an electrochemical cell may be formed accordingly and arranged opposite each other each on one side of a separator.

The coated regions may have a polygonal, circular, or elliptical outer contour. Square, hexagonal, or rectangular geometries are preferred. Coated regions may also be formed in a meandering or spiral shape.

The open porous metal structure forming the support, in particular a metal foam, may, for example, consist of or be coated with Ni, Al, Mo, Fe, Mn, Co, Cu, Zn, La, Ce, an alloy containing at least one of these chemical elements, or an intermetal-lic compound. For the coating, a metal powder selected from Ni, Fe, Mo, Co, Cu, and Ag or alloys of these metals may be used.

In order to make Raney Ni electrodes, in particular, suitable for use, both warpage and brittleness should be minimized.

According to the invention, therefore, not the entire surface of the open porous metal structure is coated. This results in a grid-like electrode that is both mechanically stable and exhibits no warpage. The uncoated areas in the form of a grid-like lattice create a type of ductile hinge point that allows the open porous metal structure with a coating to ductilely compensate for warpage. This concept results in large electrodes that are easy to manufacture, mechanically stable, and simultaneously exhibit high electrocatalytic activity or rather an increased surface area for water electrolysis.

The advantage of the electrode manufactured according to the invention over conventional electrodes, which have also been manufactured from porous brittle materials, is that it remains ductilely bendable in two spatial directions, each along the uncoated linear surface areas at an angle of at least 10° from the horizontal plane, without breaking. This represents a decisive advantage when in-stalled in an electrolyzer cell, where the contact pressure during the use of brittle electrodes can easily cause cracks or breaks in them, which can be avoided with the invention.

In surface regions where interstices are present, another material may also have been applied that exhibits properties different from those of the actual electrode material in coated regions. Such a material may, for example, exhibit greater ductility, altered wetting behavior, electrical conductivity, or catalytic activity than the electrode material.

The coating, which features interstices between coated regions, significantly increases the mechanical stability of the electrode, thereby making it much easier to carry out subsequent production steps and to install the electrode.

The invention also makes it possible to facilitate the removal of gas bubbles generated during electrolysis and to increase the energy efficiency of the electrolysis process.

It is also possible to weld the electrodes of the invention to a bipolar plate. This, too, minimizes the ohmic losses at the anode of an electrolyzer.

With the electrodes of the invention, mechanical stresses or defects that could occur, particularly during cooling after a thermal treatment, can be avoided, at least to a large extent.

The invention will be explained in the following by means of examples.

### EXAMPLE 1

As a semi-finished product, an open porous molded body made of nickel was used, having an average pore size of at least 400 μm, preferably at least 450 μm, with a porosity greater than 90%, preferably at least 95%, dimensions of 100 mm×100 mm or, for example, 70 mm×70 mm, and a thickness of less than 2 mm, for example 1.6 mm.

Subsequently, using a 2 mm wide commercially available adhesive film, narrow regions on one side on the surface to be coated can be covered both transversely and longitudinally and protected from the coating material, so that, in plan view, a pattern of 16 open porous squares with an edge length of just over 15 mm each was created, separated from one another by the 2 mm wide adhesive strips. This allowed for uncoated interstices between coated regions with a width of at least 1 mm.

For the single-sided coating of the masked porous molded body, which had a mass of 4.9 g, a metallic aluminum powder with a particle size<63 μm and a powder quantity of 1.0 g can be used.

For the one-sided coating of the surface of the open porous nickel molded body as a semi-finished product, Steramid wax and an aqueous solution of polyvinylpyrrolidone was used as binder. The surface of the semi-finished product was sprayed with the binder solution on the masked side before the aluminum powder was applied to the surface coated with the binder and evenly distributed over the surface to be coated.

The aluminum powder and Steramid wax were mixed for 10 minutes using a Turbula mixer, and the mixture was then sprinkled onto the surface of the nickel molded body that had been sprayed with the binder. Afterwards the coated sample was dried for 12 hours at room temperature, after which the adhesive tape was manually removed. The application and removal of the adhesive tape can also be performed mechanically.

This was followed by a thermal debinding treatment, during which the organic components were removed, and sintering in a nitrogen atmosphere. For this purpose, a tube furnace was heated at a heating rate of 9 K/min. The debinding process, during which the organic components were removed, took place at 500° C. with a holding time of 30 minutes. After further heating, the aluminum reacted with the struts of the open porous molded nickel body and formed various nickel aluminide phases on the surface of the coated squares. These intermetallic phases exhibited high brittleness.

The molded body, which had been partitionally coated on one side and sintered, was then leached. Leaching of the aluminum-rich phases was carried out in an aqueous solution of potassium hydroxide (1.8 M) and potassium/sodium tartrate (1.5 M) until gas evolution ceased. The samples were thoroughly washed with deionized water and stored in deionized water until use as a cathode in an alkaline laboratory electrolyzer setup.

The advantage of the electrode produced according to the invention over conventional electrodes, which are also made of porous brittle materials, is that it remained ductilely bendable in two spatial directions, each along the uncoated lines at an angle of at least 10° from the horizontal plane, without breaking. This represented a decisive advantage during installation in an electrolyzer cell, where the contact pressure exerted can easily cause cracks or breaks in brittle electrodes.

The coated regions on the surface had increased catalytic activity and an enlarged specific surface area due to the aluminide phases.

### EXAMPLE 2

An open porous nickel molded body with an average pore size of 450 μm, a porosity of approx. 95%, dimensions of 190 mm×70 mm, and a thickness of 0.5 mm was used as the semi-finished product.

For the single-sided coating of the porous molded body as an open porous metal structure, which has a mass of 5.6 g, a metallic nickel powder with an average particle size <10 μm and a powder quantity of 4.0 g was used.

For the single-sided coating of the surface of the open porous nickel molded body as a semi-finished product, a suspension of the nickel powder in an aqueous solution of polyvinylpyrrolidone was used. This suspension was homogenized in a speed mixer for 1 min. The suspension was then applied through a fine-mesh screen in a screen printing machine, where the mesh openings were free in regions measuring 80 mm×15 mm, while the intervening regions, each 3 mm wide, were closed. As a result, the rectangular regions of the semi-finished product were coated with the nickel suspension, while the regions between the rectangles remained uncoated. However, other metals or alloys can also be screen-printed.

The coated sample was then dried at room temperature for 24 hours. This resulted in uncoated interstices with a width of at least 2 mm.

Subsequently, a thermal treatment for debinding and sintering was performed in a hydrogen atmosphere. For this purpose, a tube furnace was heated at a rate of 5 K/min. Debinding took place at 500° C. with a holding time of 60 min. After further heating at 3 K/min, the sintering process then took place at 850° C. with a holding time of 120 min. During this process, the nickel particles from the former suspension sintered into a fine-pored nickel powder bed on the surface of the coated rectangles. These powder bed regions exhibit higher brittleness than the porous substrate. However, an increased specific surface area was also advantageously achieved in the coated regions after sintering.

### EXAMPLE 3

An open porous nickel molded body, with an average pore size of 580 μm, a porosity of approx. 95%, dimensions of 75 mm×75 mm, and a thickness of 1.0 mm, was used as the semi-finished product

Subsequently, narrow regions on the surface to be coated were covered on one side, both transversely and longitudinally, using a 2 mm wide commercially available adhesive film to protect them from the coating material. In the top view, a pattern of 16 open porous squares with an edge length of just over 15 mm each was created, separated from one another by the 2 mm wide strips of the film. This allowed for uncoated interstices between the coated regions, which ultimately had a width of at least 1 mm.

For the single-sided coating of the porous molded body—an open porous metal structure with a mass of 4.6 g—a nickel oxide powder with a mean particle size <1 μm and a powder quantity of 1.8 g was used.

For the single-sided coating of the surface of the open porous nickel molded body as a semi-finished product, a suspension of the nickel oxide powder in an aqueous solution of polyvinylpyrrolidone with a volume of 15 ml was used. This suspension was homogenized in a speed mixer for 2×0.5 min. The suspension was then sprayed onto one side of the nickel mold body, which had been partially masked with tape, using a paint spray gun.

The coated sample was then dried at room temperature for 24 hours, after which the film strips were removed by hand.

This was followed by a thermal treatment for calcination at 500° C. for 30 minutes in an air atmosphere in a muffle furnace. This created a surface structure with nickel oxide-coated squares on the open porous nickel molded body, which are separated from one another by the former foil strips and thus provide the entire molded body with crack-free flexibility for further use.

1. An electrode for electrochemical cells designed to perform electrolysis, wherein a support formed with an open porous metal structure is provided, on the outward-facing surface facing a separator of an electrochemical cell, with a coating that increases the specific surface area or with a coating that increases the specific surface area and exhibits increased catalytic activity,
wherein the coating is formed from a metal whose particles are bonded to one another and to the surface of the open porous metal structure via sinter bridges and/or an organic binder,
wherein the coating is formed with multiple regions, between which uncoated interstices are arranged.

2. The electrode according to claim 1, wherein the coated regions each have a maximum area of 1500 mm².

3. The electrode according to claim 1, wherein at least four coated regions are formed on the outward-facing surface.

4. The electrode according claim 1, wherein the coated regions have a polygonal, circular, elliptical, or sinuous outer contour, or the coated regions are formed in a meandering or spiral shape.

5. The electrode according to claim 1, wherein the open porous metal structure consists of metal and the coating is formed from metal powder selected from Ni, Al, Mo, Fe, Mn, Co, Cu, Zn, La, Ce, Pt, Ru, Ir, and Ag, or alloys of these metals.

6. The electrode according to claim 1, wherein at least 80% of the surface of the support on which the coated regions are formed is coated with a coating.

7. The electrode according to claim 1, wherein the electrode is formed with a catalytically active chemical element or the surface is at least partially coated therewith.

8. The electrode according to claim 2, wherein the coated regions each have a maximum area of 1200 mm².

9. The electrode according to claim 1, wherein a width of the interstices is at least 0.1 mm.

10. The electrode according to claim 9, wherein the width of the interstices is at least 0.5 mm.

11. The electrode according to claim 9, wherein the width of the interstices is at least 1 mm.

12. The electrode according to claim 5, wherein the open porous metal structure consists of a metal foam made of Ni, Al, Mo, Fe, Mn, Co, Cu, Zn, La, Ce, an alloy of at least one of these chemical elements, or an intermetallic compound.
